(19) United States
(12) Patent Application Publication
(10) Pub. No.: US 2026/0251478 A1
(43) Pub. Date: Aug. 27, 2026

(54) SPLIT MAGNETIC WHEEL ENCODER FOR ELEVATORS

(71) Applicant: Hengstler GmbH, Aldingen, Baden-Württemberg (DE)

(72) Inventors: Kenneth L. Dickinson, Columbus, OH (US); Marián Brejka, Malý Slavkov (SK); Branislav Záviš, Spišská Nová Ves (SK); Mišél Batmend, Stará Lubovna (SK); Lubomír Tkác, Švábovce (SK)

(21) Appl. No.: 19/542,427

(22) Filed: Feb. 17, 2026

Related U.S. Application Data
(60) Provisional application No. 63/761,455, filed on Feb. 21, 2025.

(51) Int. Cl. G01D 5/14; B66B 5/00

(52) U.S. Cl. CPC G01D 5/14; B66B 5/0018

(57) ABSTRACT

Systems, apparatuses, and methods provide for an elevator system with a split magnetic wheel encoder. The split magnetic wheel encoder includes a magnetic wheel comprising a first half wheel removably coupled to a second half wheel and a read head located to be adjacent to the magnetic wheel. The magnetic wheel is sized to fit between an elevator motor and an elevator motor support arm when located around an elevator motor shaft.

### FIELD

The instant disclosure relates generally to systems, apparatuses, and methods for magnetic wheel encoders. In particular, embodiments of the instant disclosure relate to systems, apparatuses, and methods for split magnetic wheel encoders for elevators.

### BACKGROUND

In the field of elevator modernization, modernizing motor feedback devices, such as encoders, is often desired. Many elevators that reach the age of 10-20 years are being modernized so that users get improved experience. Often a motor-drive system is modernized, using newer drive techniques. This sometimes requires modernizing the motor speed feedback device (e.g., an encoder).

In elevators, motors that move the elevator cabin are driven by variable frequency drive (VFD). To achieve smooth movement, especially at slow rotational speed, VFD's require a speed sensor mounted on motor shaft. Most commonly, encoders are being used as speed sensors.

In geared elevator machines, encoders are usually mounted at rear end of motor (B-side), using a flexible coupling. In case such encoder needs replacement, it is relatively easy to replace it.

However, in some gear-less elevator machines, the motor shaft is not accessible for encoder to be mounted, therefore an alternative way of encoder mounting was used in its original design. Referring to FIGS. 2-3, this alternative mounting is using a friction wheel encoder 200, which, referring to FIG. 1 is touching the outer diameter 102 of elevator motor 100 and thus measuring the motor speed. However, the friction wheel encoder 200 mounting 104 has limited lifetime. The wheel itself deforms over time, causing the slipping of wheel, which causes incorrect speed measurement. This is causing difficulties in motor control.

State of art solutions to deal with the corrupted encoder signal in some gear-less machines is encoder replacement, using a new set of encoder and friction wheel. Such solution works for limited time and needs relatively frequent encoder replacement, which is not preferred by elevator maintenance companies.

Another solution is replacing the elevator machine with newer design, which uses magnetic ring encoder firmly mounted on the motor shaft by original equipment manufacturer. However, the old machine must be disassembled and a new machine mounted. The costs of such replacement are significant.

Another solution is replacing the friction wheel encoder by magnetic ring encoder available on a market. This requires disassembly of the machine, turning the motor shaft diameter on a lathe to fit the encoder wheel size and milling some parts of machine to attach the sensor head. The operation cannot be done on-site and requires costly disassembly and transportation of elevator machine into a tool shop.

Friction wheel incremental encoders are widely used in motion control systems to measure the position and speed of rotating shafts. These encoders consist of a rotating disc with evenly spaced slots and a friction wheel that makes contact with the disc. As the wheel rotates, the slots on the disc interrupt a light beam, generating electrical signals that can be used to calculate the position and speed of the shaft. One of the main advantages of friction wheel incremental encoders is their low cost compared to other types of encoders. They are also easy to install and require minimal maintenance. However, they are limited in terms of their resolution and accuracy, which can be affected by factors such as wear and tear on the friction wheel and disc. Additionally, they may be prone to errors if there is any slippage between the wheel and the disc, which can lead to inaccuracies in the position and speed measurements. Additionally, any angular misalignment or diameter variation (due to either manufacturing, wear, or variation in down loading due to the rotary spring) is a large source of velocity error.

Magnetic ring encoders are another type of encoder used in motion control systems that measure the position and speed of rotating shafts. These encoders consist of a rotating ring with magnetic poles and a sensor that detects changes in the magnetic field as the ring rotates. The magnetic field changes generate electrical signals that can be used to calculate the position and speed of the shaft. One of the main advantages of magnetic ring encoders is their high resolution and accuracy, which makes them ideal for applications that require precise control. They are also resistant to wear and tear, making them a reliable option for long-term use. However, they are generally more expensive than other types of encoders and may require more complex installation and maintenance procedures due to their sensitive magnetic sensors. Additionally, they may be affected by external magnetic fields, which can interfere with the accuracy of the measurements.

Split magnetic wheel encoders are also known. A split wheel design allows for easiest mounting on installed shafts, where end of motor shaft is easily available. A split wheel is suitable for mounting locations without free shaft end as time consuming assembly and disassembly work is avoided. The split wheel system is particularly suitable for retrofitting and upgrade projects when the encoder needs to be integrated in an existing plant. However, existing split magnetic wheel encoders are not sized to be adapted for retrofitting existing elevator systems. This requires disassembly of the machine, turning the motor shaft diameter on a lathe to fit the split magnetic wheel encoder size. The operation cannot be done on-site and requires costly disassembly and transportation of elevator machine into a tool shop.

### SUMMARY

Advantageously, some implementations discussed herein provide easy mounting of a split magnetic ring encoder on existing gear-less elevator machines. The magnetic ring is split so that it can be mounted around an elevator motor shaft with no need to disassemble the elevator machine. Mounting of the magnetic ring is such that it requires minimum adjustments of the elevator machine. The adjustments can be made on job site, with no need to disassemble the elevator machine. The read head of the split magnetic ring encoder can be mounted on the elevator machine with no need to disassemble the elevator machine. A key advantage is in enabling upgrading the elevator machine with reliable fixed mounted split magnetic ring encoder with no need to disassemble the elevator machine.

As will be described in greater detail below, in some implementations discussed herein, systems, apparatuses, and methods provide for an elevator system with a split magnetic wheel encoder. The split magnetic wheel encoder includes a magnetic wheel comprising a first half wheel removably coupled to a second half wheel and a read head located to be adjacent to the magnetic wheel. The magnetic wheel is sized to fit between an elevator motor and an elevator motor support arm when located around an elevator motor shaft.

In one example, an encoder includes a magnetic wheel comprising a first half wheel removably coupled to a second half wheel and a read head located to be adjacent to the magnetic wheel. The magnetic wheel is sized to fit between an elevator motor and an elevator motor support arm when located around an elevator motor shaft.

In a further example, a method includes coupling a magnetic wheel of an encoder around an elevator motor shaft and locating a read head adjacent to the magnetic wheel. In this method, the magnetic wheel is sized to fit between an elevator motor and an elevator motor support arm. Further, the magnetic wheel comprises a first half wheel removably coupled to a second half wheel. Lastly, the magnetic wheel is coupled to the elevator motor shaft without disassembling the elevator motor support arm from the elevator motor.

In another example, an elevator system included an elevator motor comprising an elevator motor shaft, an elevator motor support arm coupled to the elevator motor, and an encoder coupled to the elevator motor. The encoder includes a magnetic wheel comprising a first half wheel removably coupled to a second half wheel and a read head located to be adjacent to the magnetic wheel. The magnetic wheel is sized to fit between the elevator motor and the elevator motor support arm when located around the elevator motor shaft.

This Summary is provided to introduce a selection of concepts in a simplified form that are further described below in the Detailed Description. The foregoing Summary, as well as the following Detailed Description of certain implementations, will be better understood when read in conjunction with the appended drawings. This Summary is not intended to identify key features or essential features of the claimed subject matter, nor is it intended to be used as an aid in determining the scope of the claimed subject matter.

### BRIEF DESCRIPTION OF THE DRAWINGS

The foregoing and other features and advantages will be discussed in detail in the following non-limiting description of specific embodiments in connection with the accompanying drawings, in which:

FIG. 1 is an illustration of a perspective view of an elevator system equipped to receive a friction wheel encoder;

FIG. 2 is an illustration of a perspective view of a friction wheel encoder;

FIG. 3 is an illustration of a perspective view of the back side of the friction wheel encoder;

FIG. 4 is an illustration of a perspective view of an elevator system with a split magnetic wheel encoder according to an example of the instant disclosure;

FIG. 5 is an illustration of a perspective view of the split magnetic wheel encoder according to an example of the instant disclosure;

FIG. 6 is an illustration of a perspective view of the split magnetic wheel encoder split in two according to an example of the instant disclosure;

FIG. 7 is an illustration of a side view of the split magnetic wheel encoder being installed to the elevator system according to an example of the instant disclosure;

FIG. 8 is an illustration of a perspective view of the split magnetic wheel encoder split in two according to an example of the instant disclosure;

FIG. 9 is an illustration of a perspective view of the split magnetic wheel encoder joined together according to an example of the instant disclosure;

FIG. 10 is an illustration of a perspective view of the read head of the split magnetic wheel encoder according to an example of the instant disclosure; and

FIG. 11 is a flowchart of an example of a method for coupling a magnetic wheel of an encoder around an elevator motor shaft according to an example.

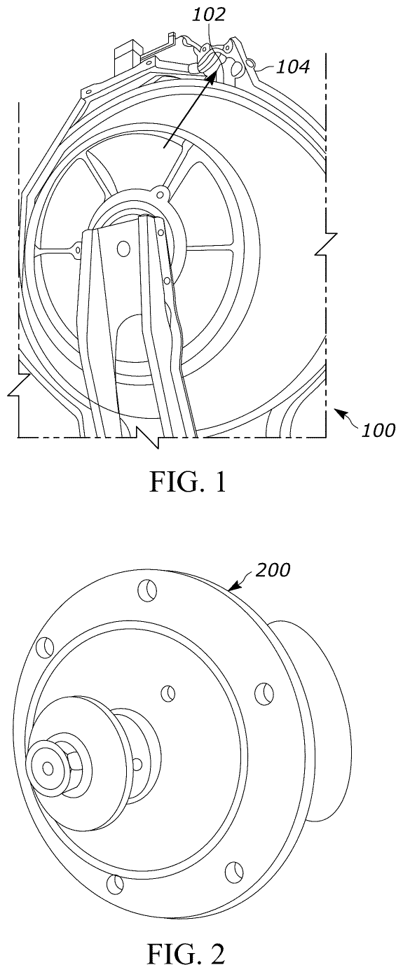

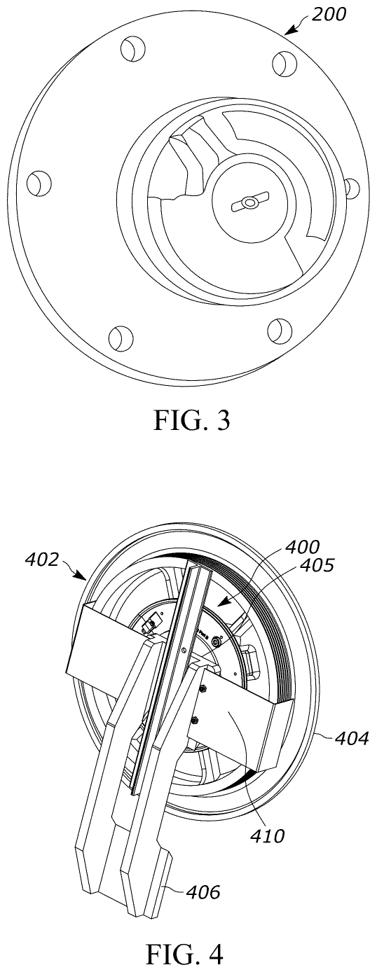

### DETAILED DESCRIPTION OF THE PRESENT EMBODIMENTS

As will be described in greater detail below, in some implementations discussed herein, systems, apparatuses, and methods provide for an elevator system with a split magnetic wheel encoder. The split magnetic wheel encoder includes a magnetic wheel comprising a first half wheel removably coupled to a second half wheel and a read head located to be adjacent to the magnetic wheel. The magnetic wheel is sized to fit between an elevator motor and an elevator motor support arm when located around an elevator motor shaft.

Advantageously, some implementations discussed herein provide easy mounting of a split magnetic ring encoder on existing gear-less elevator machines. The magnetic ring is split so that it can be mounted around an elevator motor shaft with no need to disassemble the elevator machine. Mounting of the magnetic ring is such that it requires minimum adjustments of the elevator machine. The adjustments can be made on job site, with no need to disassemble the elevator machine. The read head of the split magnetic ring encoder can be mounted on the elevator machine with no need to disassemble the elevator machine. A key advantage is in enabling upgrading the elevator machine with reliable fixed mounted split magnetic ring encoder with no need to disassemble the elevator machine.

In addition, to address unique challenges of elevator modernization, embodiments herein may also include one or more of the following features:
1) A way to tighten the halves of the magnetic wheel together—To be able to mount the encoder wheel on site, a split wheel design is used. However, split wheel requires tightening the two (or more) parts of the wheel afterwards. A screw and thread design may be used, which differs from other products available on market. In such an example, two screws are tightened after two halves of the wheel. Screw head can be easily accessed by angled hex key or other similar tool. Additionally, a dowel pin is utilized to force the two halves of the split wheel design to stay in alignment.
2) The width of the magnetic wheel is thin—Unlike existing designs, the magnetic wheel able to fit within the space available on the elevator machine.
3) The size and shape of read head—Unlike existing designs, the read head sensor is sized so that the read head can fit into the existing available elevator machine space.

FIG. 4 is an illustration of a perspective view of an elevator system 402 with a split magnetic wheel encoder 400 according to an example of the instant disclosure. As will be discussed in greater detail below, the elevator system 402 includes an elevator motor 404, an elevator motor support arm 406, and a split magnetic wheel encoder 400.

The elevator motor 404 includes an elevator motor shaft 405. The elevator motor support arm 406 is coupled to the elevator motor 404 via the elevator motor shaft 405. The split magnetic wheel encoder 400 is coupled around the elevator motor shaft 405 of the elevator motor 404.

As illustrated, the split magnetic wheel encoder 400 is sized to fit between the elevator motor 404 and the elevator motor support arm 406 when located around the elevator motor shaft 405.

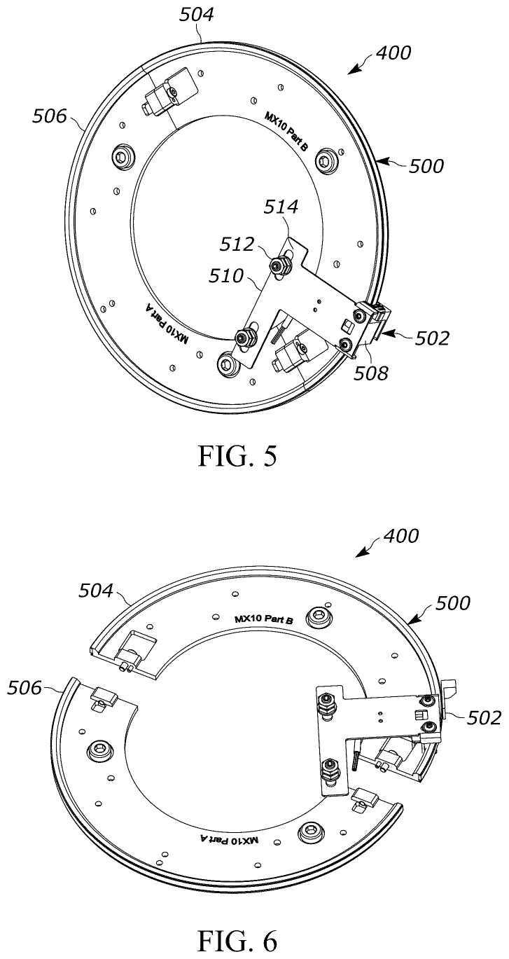

FIG. 5 is an illustration of a perspective view of the split magnetic wheel encoder 400 according to an example of the instant disclosure. As illustrated, the split magnetic wheel encoder 400 includes a magnetic wheel 500 and a read head 502.

The magnetic wheel 500 has a first half wheel 504 removably coupled to a second half wheel 506. The magnetic wheel 500 is sized to fit between the elevator motor and the elevator motor support arm when located around the elevator motor shaft.

The read head 502 is located to be adjacent to the magnetic wheel 500. The read head 502 includes a sensor 508 and a support arm 510. The support arm 510 couples to the elevator motor support arm via fasteners 512 and holds the sensor 508 in a fixed spaced arrangement with respect to the magnetic wheel 500. The support arm includes slots 514 to receive fasteners 512. The slots 514 allow adjustment of the fixed spaced arrangement with respect to the magnetic wheel 500.

FIG. 6 is an illustration of a perspective view of the split magnetic wheel encoder 400 split in two according to an example of the instant disclosure. As illustrated, the magnetic wheel 500 has a first half wheel 504 removably coupled to a second half wheel 506.

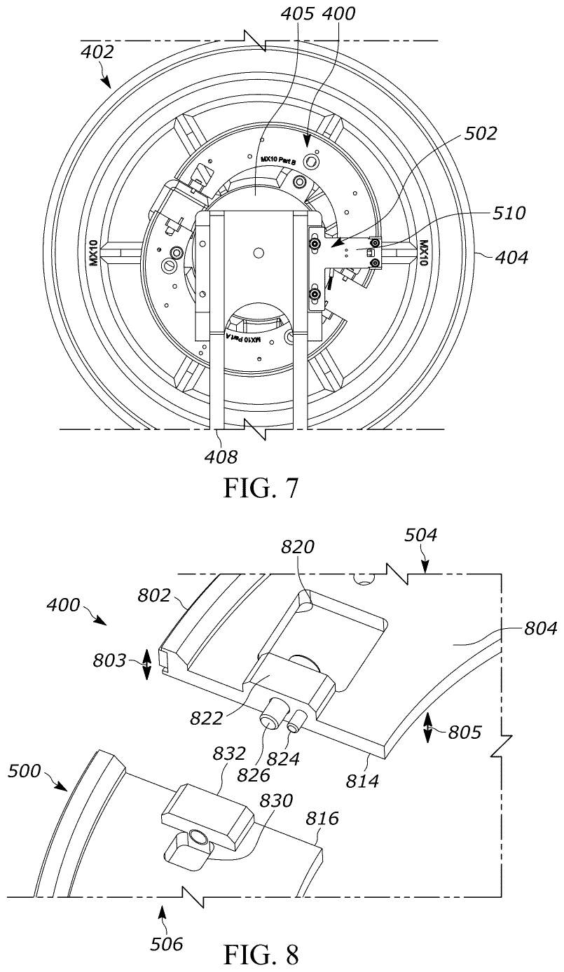

FIG. 7 is an illustration of a side view of the split magnetic wheel encoder 400 being installed to the elevator system 402 according to an example of the instant disclosure. As illustrated, the read head 502 is located to be adjacent to the magnetic wheel 500. The support arm 510 of the read head 502 couples to the elevator motor support arm 406 and holds the sensor 508 in a fixed spaced arrangement with respect to the magnetic wheel 500.

The read head 502 is sized so as to fit under a cowl 410 (See, FIG. 4) which extends from the elevator motor support arm 406 to partially cover the elevator motor 404. For example, the read head has a width between 10 millimeters and 15 millimeters.

The magnetic wheel 500 is sized to fit between the elevator motor 404 and the elevator motor support arm 406 when located around the elevator motor shaft 405. For example, the magnetic wheel 500 has a width between 5 millimeters and 20 millimeters. In some examples, the magnetic wheel 500 is coupled to the elevator motor shaft 405 without disassembling the elevator motor support arm 406 from the elevator motor 404.

FIG. 8 is an illustration of a perspective view of the split magnetic wheel encoder 400 split in two according to an example of the instant disclosure. As illustrated, the magnetic wheel 500 has an outer ring lip 802 surrounding an inner ring disk 804.

The inner ring disk 804 has a width 805 that is less than a width 803 of the outer ring lip 802, in some examples. In some implementations, the inner ring disk 804 has a width 805 between 5 millimeters and 10 millimeters while the outer ring lip 802 has a width 803 between 5 millimeters and 20 millimeters (or a width 803 between 5 millimeters and 15 millimeters in some implementations).

The first half wheel 504 has a first semicircle shape with a first end surface 814 at a termination of the first semicircle shape. The second half wheel 506 has a second semicircle shape with a second end surface 816 at a termination of the second semicircle shape.

The first half wheel 504 includes a first opening 820 in the inner ring disk 804 and a first fastener housing 822. The first fastener housing 822 is located at the first end surface 814 and adjacent the first opening 820.

The second half wheel 506 includes a second opening 830 in the inner ring disk 804 and a second fastener housing 832. The second fastener housing 832 is located at the second end surface 816 and adjacent the second opening 830.

In some examples, the first fastener housing 822 has an alignment pin 824 receivable within the second fastener housing 832.

In some implementations, a fastener 826 is used to couple the first fastener housing 822 to the second fastener housing 832. For example, the fastener may be a screw or other type of fastener.

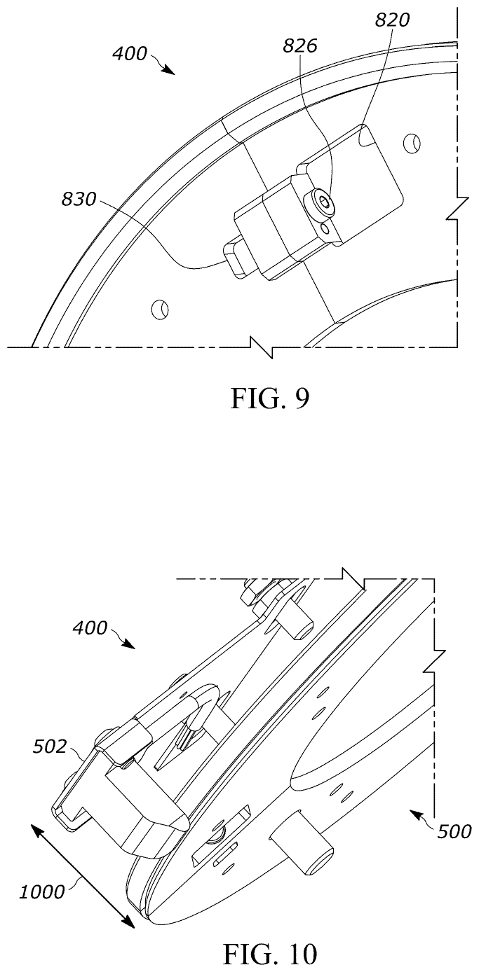

FIG. 9 is an illustration of a perspective view of the split magnetic wheel encoder 400 joined together according to an example of the instant disclosure. As illustrated, the first opening 820 is larger than the second opening 830. The first opening 820 is sized to accommodate a tool to access and tighten the fastener 826. The second opening 830 may be sized to accommodate an end of the fastener 826 when the first half wheel 504 is coupled to the second half wheel 506.

FIG. 10 is an illustration of a perspective view of the read head of the split magnetic wheel encoder 400 according to an example of the instant disclosure. As illustrated, the read head 502 is sized so as to fit under a cowl 410 (See, FIG. 4) which extends from the elevator motor support arm 406 to partially cover the elevator motor 404. For example, the read head has a width 1000 between 10 millimeters and 15 millimeters.

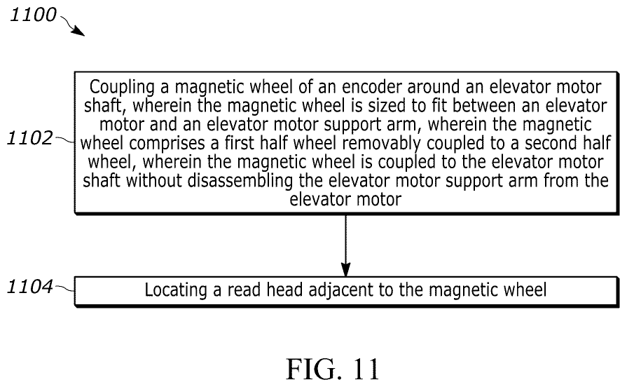

FIG. 11 is a flowchart of an example of a method 1100 for coupling a magnetic wheel of an encoder around an elevator motor shaft according to an example. The method 1100 may generally be implemented in an apparatus, such as, for example, the split magnetic ring encoder 400 (FIG. 5), already discussed.

Illustrated processing block 1102 provides for coupling a magnetic wheel of an encoder around an elevator motor shaft.

In some examples, the magnetic wheel is sized to fit between an elevator motor and an elevator motor support arm.

In some implementations, the magnetic wheel comprises a first half wheel removably coupled to a second half wheel.

In some examples, the magnetic wheel is coupled to the elevator motor shaft without disassembling the elevator motor support arm from the elevator motor.

Illustrated processing block 1104 provides for locating a read head adjacent to the magnetic wheel. For example, a read head may be located adjacent to the magnetic wheel by securing the read head to the elevator motor support arm.

### ADDITIONAL NOTES AND EXAMPLES

Clause 1 is an encoder, comprising: a magnetic wheel comprising a first half wheel removably coupled to a second half wheel, wherein the magnetic wheel is sized to fit between an elevator motor and an elevator motor support arm when located around an elevator motor shaft; and a read head located to be adjacent to the magnetic wheel.

Clause 2 includes the encoder of Clause 1, wherein the magnetic wheel has an outer ring lip surrounding an inner ring disk, wherein the inner ring disk has a width that is less than the outer ring lip.

Clause 3 includes the encoder of Clause 2, wherein the inner ring disk has a width between 5 millimeters and 10 millimeters.

Clause 4 includes the encoder of any one of Clauses 1 to 3, wherein the read head has a width between 10 millimeters and 15 millimeters.

Clause 5 includes the encoder of Clause 2, wherein the first half wheel has a first semicircle shape with a first end surface at a termination of the first semicircle shape, the second half wheel has a second semicircle shape with a second end surface at a termination of the second semicircle shape, the first half wheel comprising a first opening in the inner ring disk and a first fastener housing, wherein the first fastener housing is located at the first end surface and adjacent the first opening, and the second half wheel comprising a second opening in the inner ring disk and a second fastener housing, wherein the second fastener housing is located at the second end surface and adjacent the second opening.

Clause 6 includes the encoder of Clause 5, wherein the first fastener housing has an alignment pin receivable within the second fastener housing.

Clause 7 includes the encoder of Clause 5, further comprising a fastener to couple the first fastener housing to the second fastener housing, wherein the fastener comprises a screw.

Clause 8 includes the encoder of Clause 5, wherein the first opening is larger than the second opening.

Clause 9 is a method comprising: coupling a magnetic wheel of an encoder around an elevator motor shaft, wherein the magnetic wheel is sized to fit between an elevator motor and an elevator motor support arm, wherein the magnetic wheel comprises a first half wheel removably coupled to a second half wheel, wherein the magnetic wheel is coupled to the elevator motor shaft without disassembling the elevator motor support arm from the elevator motor; and locating a read head adjacent to the magnetic wheel.

Clause 10 includes the method of Clause 9, wherein the magnetic wheel has an outer ring lip surrounding an inner ring disk, wherein the inner ring disk has a width that is less than the outer ring lip.

Clause 11 includes the method of Clause 10, wherein the inner ring disk has a width between 5 millimeters and 10 millimeters.

Clause 12 includes the method of any one of Clauses 9 to 11, wherein the read head has a width between 10 millimeters and 15 millimeters.

Clause 13 includes the method of Clause 10, wherein the first half wheel has a first semicircle shape with a first end surface at a termination of the first semicircle shape, the second half wheel has a second semicircle shape with a second end surface at a termination of the second semicircle shape, the first half wheel comprising a first opening in the inner ring disk and a first fastener housing, wherein the first fastener housing is located at the first end surface and adjacent the first opening, and the second half wheel comprising a second opening in the inner ring disk and a second fastener housing, wherein the second fastener housing is located at the second end surface and adjacent the second opening.

Clause 14 includes the method of Clause 13, wherein the first fastener housing has an alignment pin receivable within the second fastener housing.

Clause 15 includes the method of Clause 13, further comprising a fastener to couple the first fastener housing to the second fastener housing, wherein the fastener comprises a screw.

Clause 16 includes the method of Clause 13, wherein the first opening is larger than the second opening.

Clause 17 is an elevator system, comprising: an elevator motor comprising an elevator motor shaft; an elevator motor support arm coupled to the elevator motor; and an encoder coupled to the elevator motor, the encoder comprising: a magnetic wheel comprising a first half wheel removably coupled to a second half wheel, wherein the magnetic wheel is sized to fit between the elevator motor and the elevator motor support arm when located around the elevator motor shaft; and a read head located to be adjacent to the magnetic wheel.

Clause 18 includes the elevator system of Clause 17, wherein the magnetic wheel has an outer ring lip surrounding an inner ring disk, wherein the inner ring disk has a width that is less than the outer ring lip.

Clause 19 includes the elevator system of Clause 18, wherein the inner ring disk has a width between 5 millimeters and 10 millimeters.

Clause 20 includes the elevator system of any one of Clauses 17 to 19, wherein the read head has a width between 10 millimeters and 15 millimeters.

Clause 21 includes an apparatus including means for performing the function of any preceding Clause.

All definitions, as defined and used herein, should be understood to control over dictionary definitions, definitions in documents incorporated by reference, and/or ordinary meanings of the defined terms.

Furthermore, for ease of understanding, certain functional blocks can have been delineated as separate blocks; however, these separately delineated blocks should not necessarily be construed as being in the order in which they are discussed or otherwise presented herein. For example, some blocks can be able to be performed in an alternative ordering, simultaneously, etc.

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances” unless stated or implied by context otherwise.

As used herein, the terms “coupled,” “attached,” “connected,” or “operatively connected” can be used herein to refer to any type of relationship, direct or indirect, between the components in question. For example, the terms “coupled,” “attached,” “connected,” or “operatively connected” may refer to at least a functional relationship between two elements and may encompass configurations in which the two elements are directed connected to each other, i.e., without any intervening elements, or indirectly connected to each other, i.e., with intervening elements. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action can occur, either in a direct or indirect manner.

Although a number of illustrative examples are described herein, it should be understood that numerous other modifications and examples can be devised by those skilled in the art that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent to those skilled in the art. The examples can be combined to form additional examples.

What is claimed is:

1. An encoder, comprising:
a magnetic wheel comprising a first half wheel removably coupled to a second half wheel, wherein the magnetic wheel is sized to fit between an elevator motor and an elevator motor support arm when located around an elevator motor shaft; and
a read head located to be adjacent to the magnetic wheel.

2. The encoder of claim 1, wherein the magnetic wheel has an outer ring lip surrounding an inner ring disk, wherein the inner ring disk has a width that is less than the outer ring lip.

3. The encoder of claim 2, wherein the inner ring disk has a width between 5 millimeters and 10 millimeters.

4. The encoder of claim 1, wherein the read head has a width between 10 millimeters and 15 millimeters.

5. The encoder of claim 2, wherein the first half wheel has a first semicircle shape with a first end surface at a termination of the first semicircle shape, the second half wheel has a second semicircle shape with a second end surface at a termination of the second semicircle shape,
the first half wheel comprising a first opening in the inner ring disk and a first fastener housing, wherein the first fastener housing is located at the first end surface and adjacent the first opening, and
the second half wheel comprising a second opening in the inner ring disk and a second fastener housing, wherein the second fastener housing is located at the second end surface and adjacent the second opening.

6. The encoder of claim 5, wherein the first fastener housing has an alignment pin receivable within the second fastener housing.

7. The encoder of claim 5, further comprising a fastener to couple the first fastener housing to the second fastener housing, wherein the fastener comprises a screw.

8. The encoder of claim 5, wherein the first opening is larger than the second opening.

9. A method comprising:
coupling a magnetic wheel of an encoder around an elevator motor shaft, wherein the magnetic wheel is sized to fit between an elevator motor and an elevator motor support arm, wherein the magnetic wheel comprises a first half wheel removably coupled to a second half wheel, wherein the magnetic wheel is coupled to the elevator motor shaft without disassembling the elevator motor support arm from the elevator motor; and
locating a read head adjacent to the magnetic wheel.

10. The method of claim 9, wherein the magnetic wheel has an outer ring lip surrounding an inner ring disk, wherein the inner ring disk has a width that is less than the outer ring lip.

11. The method of claim 10, wherein the inner ring disk has a width between 5 millimeters and 10 millimeters.

12. The method of claim 9, wherein the read head has a width between 10 millimeters and 15 millimeters.

13. The method of claim 10, wherein the first half wheel has a first semicircle shape with a first end surface at a termination of the first semicircle shape, the second half wheel has a second semicircle shape with a second end surface at a termination of the second semicircle shape,
the first half wheel comprising a first opening in the inner ring disk and a first fastener housing, wherein the first fastener housing is located at the first end surface and adjacent the first opening, and
the second half wheel comprising a second opening in the inner ring disk and a second fastener housing, wherein the second fastener housing is located at the second end surface and adjacent the second opening.

14. The method of claim 13, wherein the first fastener housing has an alignment pin receivable within the second fastener housing.

15. The method of claim 13, further comprising a fastener to couple the first fastener housing to the second fastener housing, wherein the fastener comprises a screw.

16. The method of claim 13, wherein the first opening is larger than the second opening.

17. An elevator system, comprising:
an elevator motor comprising an elevator motor shaft;
an elevator motor support arm coupled to the elevator motor; and
an encoder coupled to the elevator motor, the encoder comprising:
a magnetic wheel comprising a first half wheel removably coupled to a second half wheel, wherein the magnetic wheel is sized to fit between the elevator motor and the elevator motor support arm when located around the elevator motor shaft; and
a read head located to be adjacent to the magnetic wheel.

18. The elevator system of claim 17, wherein the magnetic wheel has an outer ring lip surrounding an inner ring disk, wherein the inner ring disk has a width that is less than the outer ring lip.

19. The elevator system of claim 18, wherein the inner ring disk has a width between 5 millimeters and 10 millimeters.

20. The elevator system of claim 17, wherein the read head has a width between 10 millimeters and 15 millimeters.
